(19) United States
(12) Patent Application Publication
(10) Pub. No.: US 2013/0014501 A1
(43) Pub. Date: Jan. 17, 2013

(54) TUNABLE STIFFNESS ACTUATOR

(71) Applicants: Ravindra Brammajyosula, Guntur (IN); Vidyashankar R. Buravalla, Bangalore (IN)

(72) Inventors: Ravindra Brammajyosula, Guntur (IN); Vidyashankar R. Buravalla, Bangalore (IN)

(73) Assignee: GM GLOBAL TECHNOLOGY OPERATIONS LLC, Detroit, MI (US)

(21) Appl. No.: 13/471,784

(22) Filed: May 15, 2012

(30) Foreign Application Priority Data
Jul. 11, 2011 (IN) 2360/CHE/2011

(51) Int. Cl. F03G 7/06

(52) U.S. Cl. 60/527

(57) ABSTRACT

An actuator configured for tunable stiffness control and method is provided. The actuator includes a plurality of stiffness elements, one or more of the stiffness elements including a shape memory alloy (SMA). At least one of the elements has a stiffness characteristic different from another of the stiffness elements. The stiffness elements are actuable individually or in combination to provide an intermediate actuation output, which may be provided by partially transforming the smart material of one or more stiffness elements during actuation. Two or more of the stiffness elements may be actuable in combination to provide a combined output which may be non-linear, or may be functionally substitutional for an individual output of another stiffness element. The actuator may be actuable to provide a first and second output for the substantially same input, or may be selectively actuable to offset degradation of one or more of the stiffness elements.

### CROSS-REFERENCE TO RELATED APPLICATIONS

This application claims the benefit of India Provisional Patent Application No. 2360/CHE/2011, filed Jul. 11, 2011, which is hereby incorporated by reference in its entirety.

### TECHNICAL FIELD

The present invention relates to stiffness control using smart actuators.

### BACKGROUND

Smart actuators are typically operated at two distinct levels of an output characteristic, for example, force or stroke. A smart actuator including a two-way shape memory alloy (SMA) is typically configured to operate at one of two discrete output levels. The first output level represents the SMA in a first shape corresponding to a fully austenitic structure, and the second output level represents the SMA in a second shape corresponding to a fully martensitic structure. A device thus actuated may be characterized by incremental output levels or may be limited, for example, to on/off actuation. It may be desirable to have the capability to actuate the device at one or more intermediate levels between the first and second discrete output levels to provide a smoother, more continuous output characteristic.

Selection of a smart actuator may require consideration of the worst case, or most extreme, usage condition anticipated for the actuated device, which may include worst case conditions which correspond to a very low probability of occurrence. Selecting a smart actuator with the capability to respond at a first or second output level to this worst case condition may require selection of a smart actuator with an operating or output range which is significantly wider than the output range required to satisfy the 95^{th} percentile usage profile. Further, an SMA actuator which is configured to respond at the worst case condition may require a higher energy input to be actuated at the corresponding output level, increasing energy demand on the system which includes the actuated device. To deliver the force or stroke required to respond to the worst case condition, the SMA actuator may be heated to high temperatures, potentially decreasing the useful life of the SMA actuator or deteriorating the output response of the SMA actuator as it ages.

### SUMMARY

It may be desirable to configure an actuator using smart materials to provide an intermediate actuation output to optimize the performance of the actuated device, for example, to operate the actuated device at an intermediate operating level and/or to provide a smoother, more continuous output characteristic. Further, it may be desirable to provide an actuator capable of selectively responding to worst case requirements, while maintaining a lower current draw for typical usage conditions and for system efficiency and to minimize actuator degradation due to repeated actuation at higher temperatures.

A tunable stiffness actuator is provided herein, which is configured to provide an intermediate actuation output to an actuated device, such that the actuated device may be operable at an intermediate actuation level, which may be characterized by a smooth or continuous output or operating characteristic. An “intermediate actuation” as that term is used herein, is intended to describe an operating condition of an actuated device which is between a fully actuated condition (e.g., fully on, completely open, etc.) and a fully deactuated or deactivated condition (e.g., fully off, completely closed, etc.) of the SMA element or plurality of SMA elements defining the actuator. An “intermediate actuation output” as that term is used herein, is intended to describe the output of a smart actuator which causes an actuated device to function at an “intermediate actuation” operating condition. An “intermediate actuation output” may refer to a discrete output value or to a range of output values which is intermediate between the lowest and the highest actuated output for which the actuator may be configured.

An actuator adaptable for stiffness control is provided. The actuator includes a plurality of stiffness elements and is configured to actuate one or more of the stiffness elements to provide an intermediate actuation output. One or more of the plurality of stiffness elements include a smart material, which may be a shape memory alloy (SMA) configured, for example, as a SMA wire or a SMA spring. At least one of the plurality of stiffness elements comprising the actuator has a stiffness characteristic which is different from at least another of the plurality of stiffness elements.

Various configurations of the actuator are possible to provide the intermediate actuation output. For example, the intermediate actuation output may be provided by actuating one or more of the stiffness elements to partially, but not fully, transform the smart material of the one or more stiffness elements. The actuator may be configured such that two or more of the plurality of stiffness elements are actuable in combination to provide a combined output such that the combined output defines the intermediate actuation output. Two or more of the stiffness elements comprising the actuator may be configured to be actuable in parallel with each other, in series with each other, or in a combination of parallel and series to provide the combined output.

The actuator may be configured to provide an intermediate actuation output which is non-linear. In another configuration, the actuator may include two or more stiffness elements configured to provide a combined output which is functionally substitutional for an individual output of at least one other of the stiffness elements. The actuator may be actuable to provide a first output defining a first intermediate actuation output and a second output defining a second intermediate actuation output. The first output and the second output may be provided in response to substantially the same heat or power input, using, for example, a first combination and a second combination of stiffness elements to provide the first output and the second output, respectively.

The actuator may be included in a tunable stiffness control system. The system may further include an output element operatively connected to the actuator such that the output element may be actuated by an output from the actuator to be operable at an intermediate actuation level. The system may further include an input element in operative communication with the actuator and configured to activate the actuator to actuate at least one of the plurality of stiffness elements to provide the intermediate actuation output. The actuator may be configured to selectively actuate at least one of the plurality of stiffness elements to offset change in one or more of the plurality of stiffness elements, wherein the change is resultant from one or more of fatigue, function degradation, aging, shakedown, and elongation of the one or more of the plurality of stiffness elements.

A method for providing tunable stiffness control is described herein. The method includes providing an actuator comprised of a plurality of stiffness elements. Each of the plurality of stiffness elements may include a smart material, and at least one of the stiffness elements comprising the actuator may have a stiffness characteristic which is different from at least another of the stiffness elements. The method further includes selectively actuating at least one of the plurality of stiffness elements to provide an actuator output including an intermediate actuation output. The actuator output may be provided to an output element operatively connected to the actuator, such that the output element is operable at an intermediate actuation.

Selectively actuating at least one of the plurality of stiffness elements to provide the actuator output may include providing an input to the actuator, and activating the actuator in response to the input to provide the intermediate actuation output, wherein the actuator output is defined by the input. The input may be configured to activate the actuator in response to the input to provide either a first intermediate actuation output or a second intermediate actuation output.

The method may include actuating the actuator to provide one of an individual output and a combined output, where at least two of the plurality of elements are configured to provide the combined output, and at least one other of the plurality of elements is configured to provide the individual output such that the combined output and the individual output are functionally substitutional for each other. The method may further include monitoring the output of the actuator to determine whether the one of the individual output and the combined output has been provided as an actuator output and actuating the actuator to provide the other of the individual output and the combined output when the one of the individual output and the combined output has not been not provided.

The method may include monitoring the actuator output to detect a change in the actuator output resultant from deterioration of one or more of the plurality of stiffness elements due to one or more of fatigue, functional degradation, aging, shakedown, and elongation of the one or more of the plurality of stiffness elements, and selectively actuating at least one of the plurality of stiffness elements to provide an actuator output which offsets the deterioration.

The above features and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of an actuation cycle of a plurality of shape memory alloy (SMA) stiffness elements each having a different stiffness;

FIG. 2 is a schematic illustration of an actuator including a plurality of SMA stiffness elements configured in parallel;

FIG. 3 is a schematic illustration of an actuator including a plurality of SMA stiffness elements configured in parallel and in series;

FIG. 4 is a schematic illustration of the output of an actuation cycle of the plurality of SMA stiffness elements excerpted from FIG. 1;

FIG. 5 is a schematic illustration of the output of an actuation cycle of a plurality of SMA stiffness elements including the output of a plurality of SMA stiffness elements in series;

FIG. 6A is a schematic illustration of the input to an actuation cycle of a plurality of SMA stiffness elements;

FIG. 6B is a schematic illustration of the output of an actuation cycle of a plurality of SMA stiffness elements configured to provide a first intermediate actuation output and a second intermediate actuation output of the actuator;

FIG. 7 is a schematic illustration of an actuator including a plurality of stiffness elements including an SMA stiffness element and configured in parallel; and

FIG. 8 is a schematic illustration of an actuator including a plurality of SMA stiffness elements including an SMA stiffness element and configured in parallel and in series.

### DETAILED DESCRIPTION

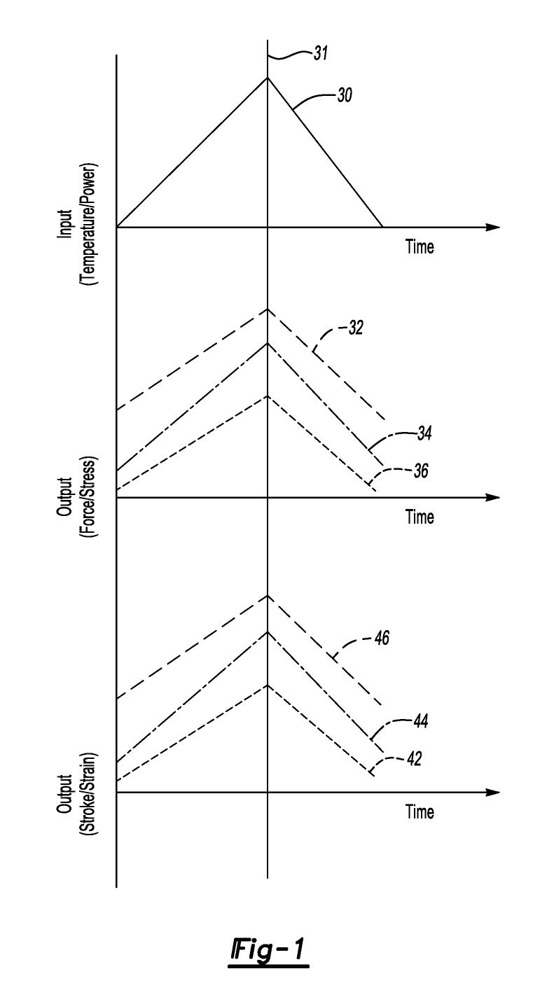

Referring to the drawings wherein like reference numbers represent like components throughout the several figures. The elements shown in FIGS. 1-6B are not to scale or proportion. Accordingly, the particular representations, dimensions and applications provided in the drawings presented herein are not to be considered limiting.

FIG. 1 shows a schematic illustration of an actuation cycle 30 of a plurality of shape memory alloy (SMA) elements which are each configured as a stiffness element. Each of the plurality of SMA elements which may be formed by a wire of shape memory alloy in a predetermined first shape, which may be, for example, a shrunk or contracted shape which is memorized by the SMA wire at a predetermined high temperature, e.g., its transformation temperature. The SMA element is transformed (formed) by application of a shaping force at a lower temperature, e.g., a temperature below the transformation temperature, to a second shape and typically retains this second shape until heated by temperature or applied current above the transformation temperature, whereby the SMA element above the transformation temperature transforms from the second shape into its predetermined first shape. Upon cooling below the transformation temperature, the SMA element than converts back into its second shape from its first shape.

The actuation cycle 30 includes a period of increasing input up to a time 31, followed by a period of decreasing input. During the period of increasing input, the SMA element is heated by, for example, increasing the ambient temperature of the SMA element or by providing a power input to the SMA element, which may be an electrical current, to resistively heat the SMA element thereby increasing its temperature. At time 31, the input is decreased, e.g., the ambient temperature of the SMA element is decreased or the power input to the SMA element is decreased or ceased such that the temperature of the SMA element is decreased.

As the temperature of the SMA element is increased above the transformation temperature of the SMA material, the SMA element undergoes transformation from a lower temperature state, generally referred to as a martensitic state, to a higher temperature state, generally referred to as an austenitic state, and the shape of the SMA element transforms from its second (martensitic) shape to its first (austenitic) shape, as described previously. As the temperature of the SMA element is decreased below the transformation temperature of the SMA material, the SMA element undergoes transformation from the higher temperature, e.g., austenitic state, to the lower temperature, e.g., martensitic state, and the shape of the SMA element transforms from its first (austenitic) shape to its second (martensitic) shape. The SMA element can therefore be configured for use as an actuator, by changing the temperature of the SMA element above and below a transformation temperature defined by the SMA material to cause a change in the shape of the SMA element which can be used to apply a force to/against an actuated member with a given stroke. An actuator configured in this manner may be used, for example, to engage/disengage an actuated member from another member or to displace an actuated member.

FIG. 1 shows the output curves for a plurality of stiffness elements as each of the stiffness elements is actuated or activated through an actuation cycle 30, which, as described previously, includes heating the SMA element until time 31, and cooling the SMA element, after time 31, wherein the element at time 31 has been heated sufficiently to fully transform the SMA element from its second (lower temperature) shape to its first (higher temperature) shape. It would be understood that the SMA element, as it transforms from its lower temperature shape to its upper temperature shape, and vice versa, will be defined by an intermediate shape which corresponds to the SMA element in a partially transformed state, e.g., the intermediate shape of the SMA element corresponds to its shape when the SMA material of the SMA element is partially defined by a martensitic structure and partially defined by an austenitic structure.

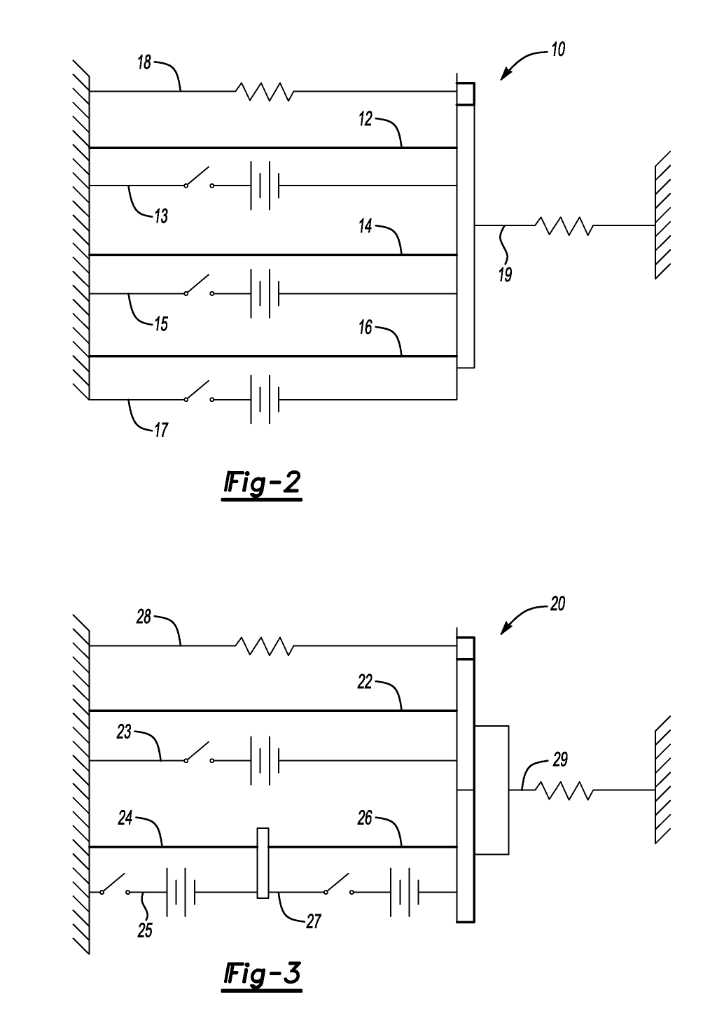

The plurality of stiffness elements may be configured, in a non-limiting example, as a first, second and third SMA element 12, 14 and 16 as shown in FIG. 2, or may be configured, in another non-limiting example, as a first, second and third SMA element 22, 24, 26 as shown in FIG. 3. The first stiffness element 12, 22 may be characterized by a force/stress output indicated at 32 and a stroke/strain output indicated at 42 in FIG. 1, and may be further characterized by a stiffness characteristic K₃. The second stiffness element 14, 24 may be characterized by a force/stress output indicated at 34 and a stroke/strain output indicated at 44 in FIG. 1, and may be further characterized by a stiffness characteristic K₂. The third stiffness element 16, 26 may be characterized by a force/stress output indicated at 36 and a stroke/strain output indicated at 46 in FIG. 1, and may be further characterized by a stiffness characteristic K₁. In the non-limiting example shown in FIG. 1, the stiffness characteristics are such that K₁<K₂<K₃, and for any given input, the force output 32 of the first element 12, 22 is greater than the force output 34 of the second element 14, 24 which is greater than the force output 36 of the third element 14, 26. Likewise, given that K₁<K₂<K₃, for any given input the stroke output 42 of the first element 12, 22 is less than the stroke output 44 of the second element 14, 24 which is less than the stroke output 46 of the third element 14, 26.

An actuator 10 is shown in FIG. 2. The actuator 10 includes a plurality of SMA elements, which in a non-limiting example, includes a first, second and third SMA element 12, 14 and 16 configured in parallel with each other, such that each of the SMA elements 12, 14, 16 are actuable individually or in combination with one or more of the other SMA elements. Each of the plurality of stiffness elements may be configured differently from one or more of the other stiffness elements. For example, a stiffness element may be configured as a SMA wire, a SMA spring, or may have a different cross-section or diameter than another of the plurality of stiffness elements. One or more of the plurality of stiffness elements may be configured of an SMA material which is different from the SMA material used for another of the stiffness elements. At least one of the plurality of stiffness elements comprising the actuator 10 has a stiffness characteristic which is different from at least another of the plurality of stiffness elements.

In the non-limiting example, referring to FIG. 1 and wherein K₁<K₂<K₃, the first SMA element 12 is defined by a force/stress output 32, a stroke/strain output 42, and a stiffness characteristic K₃. The second stiffness element 14 is defined by a force/stress output 34, a stroke/strain output 44, and a stiffness characteristic K₂. The third stiffness element 16 is defined by a force/stress output 36, a stroke/strain output 46, and a stiffness characteristic K₁.

The ends of each of the plurality of SMA wires 12, 14, 16 in actuator 10 are connected to an actuating source, for example, an electrical circuit through which current may be provided to each of the SMA elements 12, 14, 16 such that each of the SMA elements 12, 14, 16 is actuable by elevating the temperature of the respective SMA element through resistance heating. In a non-limiting example, each of the SMA elements 12, 14, 16 may be operatively connected to one or more sensors or switches, or to a controller which is responsive to at least one sensor, where the at least one sensor is sensing an operating characteristic of a system, and providing a signal to the wire, switch or controller in response to changes in the operating characteristic being sensed. Other methods of thermally actuating the SMA elements 12, 14, 16 may be employed, as would be understood by those skilled in the art.

The actuating source may be, as shown in FIG. 2, a switch and a power supply such that when the switch is closed, an electrical current is flowed from the power supply to the SMA wire and heat is generated by a resistance of the wire itself, increasing the temperature of the wire sufficiently such that the SMA wire is activated and begins to transform from its martensitic state to its austenitic state, e.g., from its second shape to its first shrunk or predetermined shape, providing a tensile force on the spring 19. When the switch is turned off or opened to shut off or cease the supply of electrical current to the SMA element, the SMA element is deactivated such that it cools and transforms to its second shape, thereby extending in length and in so doing, providing a compressive force from the actuator 10 against the spring 19.

FIG. 2 shows the first SMA element 12 operatively connected to a switch and a power supply such that the switch 13 may be closed to provide a current to the SMA element 12, thus heating the element 12. The switch 13 may be opened to cease the supply of current to element 12, causing element 12 to decrease in temperature. Similarly, the second SMA element 14 is operatively connected to a switch 15 and a power supply, and the third SMA element 16 is operatively connected to a switch 17 and a power supply. The power supply may be configured as an individual power supply for each element or as a shared power supply for two or more of the SMA elements 12, 14, 16.

The actuator 10 further includes a bias spring 18. The bias spring 18 may be configured to provide a nominal bias force on each of the SMA elements 12, 14, 16 in their respective second shape, to assist with the return of the SMA element from the first shape to the second shape during the cooling portion of the actuation cycle. The actuator 10 may include more than one bias spring, such that each SMA element 12, 14, 16 may have its own bias spring corresponding to the individual configuration of that specific SMA element.

The actuator 10 includes an actuable spring 19, which may be operatively connected to an actuable device (not shown). By changing the shape of one or more of the SMA elements 12, 14, 16, the actuator 10 actuates the actuable device via the actuable spring 19, by applying a force to or against the actuable spring 19 such that the actuable spring 19 is compressed or extended. The actuable spring 19 may be operatively connected to a device/member/etc. such that compression or extension of the actuable spring 19 causes the device/member/etc. to be activated. For example, the actuable spring 19 may be operatively connected to an actuable device such as a vent or a valve such that the actuable spring 19 may be actuated by actuator 10 to cause the vent or the valve to be opened or closed.

By configuring an actuator with a plurality of actuable stiffness elements in parallel (as shown for actuator 10 in FIG. 2), in series, or in a combination of thereof (as shown for actuator 20 in FIG. 3), with an actuable device (via the actuable spring 19, 29 in FIGS. 2, 3 respectively), a stiffness element or a plurality of combinations of actuable stiffness elements may be activated and deactivated at various times and in various sequences to provide a specific and refined response to input conditions, which may include an intermediate actuation response or output, therefore enhancing the capability to respond to multiple variables and a broader scope of inputs. An “intermediate actuation” as that term is used herein, is intended to describe an operating condition of an actuated device which is between a fully actuated condition (e.g., fully on, completely open, etc.) and a fully deactuated or deactivated condition (e.g., fully off, completely closed, etc.). An “intermediate actuation output” as that term is used herein, is intended to describe the output of a smart actuator which causes an actuated device to function at an “intermediate actuation” operating condition.

Further, any one actuable stiffness element or a plurality of combinations of actuable stiffness elements in an actuator such as the actuator 10, 20 may be activated and/or deactivated to/from a partially transformed SMA condition at various times and in various sequences to provide a specific and refined response, which may include an intermediate actuation response or output, to input conditions, therefore enhancing the capability to respond to multiple variables and a broader scope of inputs. For example, a SMA stiffness element may be partially activated, such that the SMA material is partially transformed, e.g., is not fully transformed from a martensitic to an austenitic shape and is therefore in a condition of “intermediate actuation.” In the partially activated, or partially transformed condition, the SMA element is defined by an intermediate shape which provides an “intermediate actuation output,” e.g., a force or stroke of a magnitude between the force or stroke provided when the SMA element is in a fully austenitic (first or fully activated) shape and when the SMA element is in a fully martensitic (second or fully deactivated) shape.

As another example, the SMA stiffness element may be partially deactivated, such that the SMA material is not fully transformed from a fully austenitic (first) shape to a fully martensitic (second) shape, and is in a condition of “intermediate actuation.” The intermediate shape of the partially transformed stiffness element is defined by an SMA material structure which is partially composed of an austenitic (or high temperature) structure, and of a martensitic (or low temperature) structure, which provides an “intermediate actuation output.” It would be understood that more than one intermediate shape, and correspondingly, more than one intermediate actuation output, is possible for a particular stiffness element, as the proportion of austenite to martensite in the partially transformed SMA material changes as the stiffness element is heated and/or cooled.

An actuator may be configured to provide an output including full or partial activation and deactivation or a sequence of full and/or partial activations and deactivations of one or a plurality of combinations of actuable stiffness elements in response to a signal received from a sensor or a controller in operative communication with the actuator. For example, the sensor may sense changes in an operating characteristic and signal the controller to activate one or more of the stiffness elements in the actuator to respond to the operating characteristic with an intermediate actuation of the actuated device. The intermediate actuation output provided by the actuator may be defined by a sequential or concurrent actuation of one or more of the stiffness elements of the actuator to a fully or partially activated and/or deactivated level. The sensor and the controller may provide signals on a continuous basis to the actuating source such that the actuator may provide a dynamic intermediate actuation output to the actuated device such that the actuated device responds in a continuous or non-linear fashion.

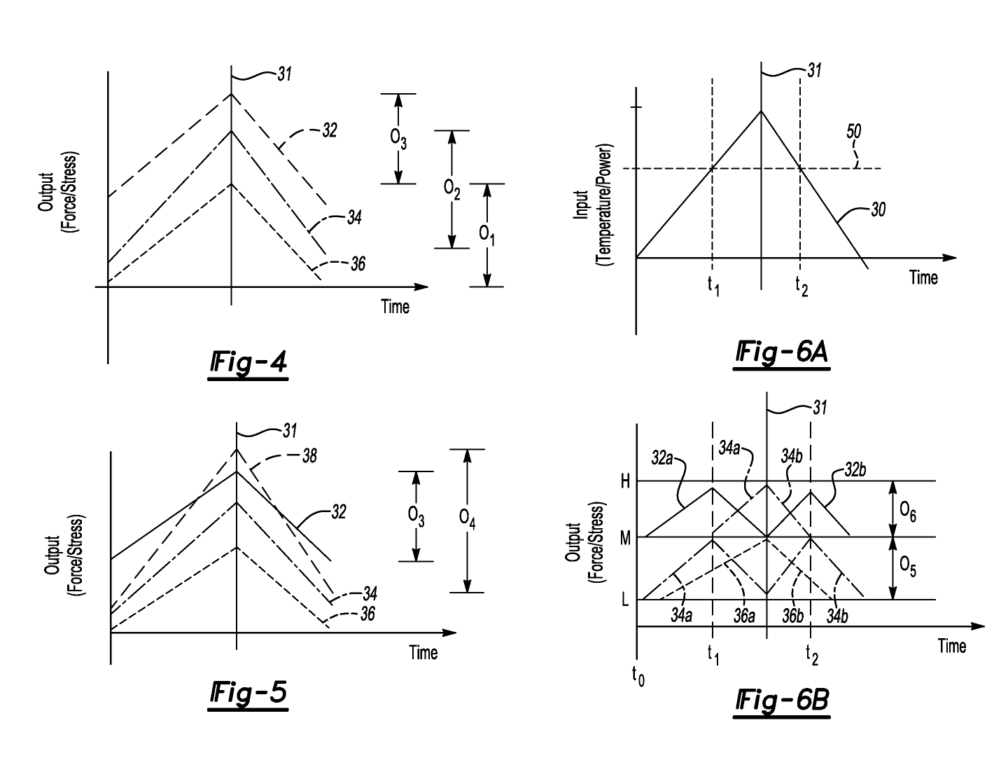

FIG. 4 shows the force output curves excerpted from FIG. 1 for the three stiffness elements 12, 14, 16 shown in the actuator 10 of FIG. 2. As discussed previously, each stiffness element has an operating, or output range associated with its activation or actuation cycle, which is bounded at one end by the output of the stiffness element when fully activated and bounded at the other end by the output of the stiffness element when fully deactivated. For example, in a typical actuation cycle, the first stiffness element 12 provides a force output 32 which has an operating output range shown in FIG. 4 as O₃, the second stiffness element 14 provides a force output 34 which has an operating output range shown as O₂, and the third stiffness element 16 provides a force output 36 which has an output range shown as O₁. In a typical actuation cycle, for example, of the stiffness element 12, the stiffness element is fully activated or transformed such that the actuated device is displace in a linear fashion, to operate at the upper limit of the output range O₃, and is fully deactivated to return to an output corresponding to the lower limit of the output range O₃.

As shown in FIGS. 6A and 6B in a non-limiting example, the stiffness elements 12, 14, 16 can be activated in combination and in sequence to define at least two operating outputs, identified as O₅ and O₆, which each represent an intermediate output or intermediate output range of actuator 10 of FIG. 2, and which each represent a combined output, e.g., the output of two or more of the stiffness elements acting in combination. The intermediate output O₅, for example, has a force output which corresponds to a low (L) to medium (M) or L-M force output and is a combined output from the selective actuation of the stiffness elements 14 and 16. The intermediate output O₆, has a force output which corresponds to a medium (M) to high (H) or M-H output and is a combined output from the selective actuation of the stiffness elements 12 and 14. Each of the intermediate outputs O₅, O₆, represent a narrower range of output as compared with the output range of any fully activated single stiffness element, e.g., the absolute range of each of the intermediate outputs O₅, O₆ is smaller than the absolute range of any one of the single element outputs O₁, O₂, O₃.

The actuator 10 of FIG. 2 may be actuated to provide the combined and intermediate output O₆ shown in FIG. 6B, by sequentially activating and deactivating the stiffness elements 12, 14. Referring now to the force output curve of FIG. 4 and the actuation cycle shown in FIG. 6A, the intermediate output O₆ (see FIG. 6B) is provided by activating the stiffness elements 12 and 14, which are arranged in parallel in actuator 10 concurrently from time t₀ to time t₁. The combined output O₆ from actuator 10 during this portion of the actuation cycle is equivalent to the intermediate output of the stiffness element 12 and is shown as output 32a, which is the higher force output of the two stiffness elements 12, 14 acting in parallel from time t₀ to time t₁. At time t₁, the first and second stiffness elements 12, 14 are still partially transformed, e.g., the force output for each element at time t₁ corresponds to an intermediate or partially transformed shape of the respective element. At time t₁, the first stiffness element 12 is deactivated such that from time t₁ to time 31, the first stiffness element 12 begins to cool and transform from an intermediate shape at t₁ to another less austenitic intermediate shape at time 31, having had insufficient time to fully transform to its fully deactivated or fully martensitic shape. From t₁ through time 31, the combined intermediate output response O₆ of actuator 10 transitions from the declining force output 32a of the deactivating element 12 to the increasing force output 34a of the stiffness element 14 as the stiffness element 14 completes its full transformation to its first shape at time 31, where the stronger output of the two elements 12, 14 is equivalent to the combined output response O₆ of the actuator 10 at any point between t₁ and time 31.

At time 31, the second stiffness element 14 is deactivated such that from time 31 to t₂, the second stiffness element 14 begins to cool and transform from its fully transformed austenitic or first shape at time 31 to an intermediate shape at time t₂. Concurrently at time 31, the first stiffness element 12 is reactivated from a partially transformed intermediate shape, having had insufficient time to fully transform to its fully deactivated or fully martensitic shape, and transforms to another, increasingly austenitic, intermediate shape from time 31 to t₂. From time 31 through time t₂, the combined intermediate output O₆ of actuator 10 transitions from the declining force output 34b of the deactivating element 14 to the increasing force output 32b of the reactivated stiffness element 12 as it transforms to an increasingly austenitic intermediate shape from time 31 to t₂, where the stronger output of the two elements 12, 14 is equivalent to the combined intermediate output O₆ at any point between time 31 and t₂. At time t₂, the first stiffness element 12 is deactivated a second time, such that the actuator intermediate output O₆ from t₂ until the end of the actuation cycle is the combined response of the deactivating elements 12, 14, and is equivalent to the force output 32b which is greater than the force output of the deactivating element 14. The force output 32b of the deactivating element 12 corresponds to an intermediate shape at time t₂ which is partially transformed to an SMA structure which is more austenitic than the partially transformed SMA structure of element 12 at the end of the actuation cycle illustrated in FIGS. 6A and 6B. By sequentially activating and deactivating the stiffness elements 12, 14 as shown in FIG. 6B and previously described, the actuator 10 can provide an intermediate actuation output in the range O₆, to operate the actuated device continuously in the medium to high (M-H) range, where the intermediate actuation output O₆ is non-linear and thereby a smoother or more continuous actuation in a narrower range than that which may be obtainable by actuation of either of the stiffness elements 12, 14 individually.

Similarly, the actuator 10 of FIG. 2 may be actuated to provide the combined and intermediate output O₅ shown in FIG. 6B, by sequentially activating and deactivating the stiffness elements 14, 16. Referring now to the force output curve of FIG. 4 and the actuation cycle shown in FIG. 6A, intermediate output O₅ (see FIG. 6B) is provided by activating the stiffness elements 14 and 16, which are arranged in parallel in actuator 10, concurrently from time t₀ to time t₁. The combined output O₅ from actuator 10 during this portion of the actuation cycle is equivalent to the stiffness element 14 and is shown as intermediate output 34a, which is the higher force output of the two stiffness elements 14, 16 acting in parallel from time t₀ to time t₁. At time t₁, the second and third stiffness elements are still partially transformed, e.g., the force output for each element at time t₁ corresponds to an intermediate or partially transformed shape of the respective element. At time t₁, the second stiffness element 14 is deactivated such that from time t₁ to time 31, the second stiffness element 14 begins to cool and transform from an intermediate shape at t₁ to another less austenitic intermediate shape at time 31, having had insufficient time to fully transform to its fully deactivated or fully martensitic shape. From t₁ through time 31, the combined intermediate output O₅ of actuator 10 transitions from the declining force output 34a of the deactivating element 14 to the increasing force output 36a of the stiffness element 16 as it completes its full austenitic transformation to its first shape at time 31, where the stronger output of the two elements 14, 16 is equivalent to the combined intermediate output O₅ of the actuator 10 at any point between t₁ and time 31.

At time 31, the third stiffness element 16 is deactivated such that from time 31 to t₂, the third stiffness element 16 begins to cool and transform from its fully transformed austenitic or first shape at time 31 to an intermediate shape at time t₂. Concurrently at time 31, the second stiffness element 14 is reactivated from a partially transformed intermediate shape, having had insufficient time to fully transform to its fully deactivated or fully martensitic shape, and transforms to another, increasingly austenitic, intermediate shape from time 31 to t₂. From time 31 through time t₂, the combined response O₅ of the actuator 10 transitions from the declining intermediate force output 36b of the deactivating element 16 to the increasing intermediate force output 34b of the reactivated stiffness element 14 as it transforms to an increasingly austenitic intermediate shape from time 31 to t₂, where the stronger output of the two elements 14, 16 is equivalent to the combined intermediate output O₅ at any point between time 31 and time t₂. At time t₂, the second stiffness element 14 is deactivated a second time, such that the actuator output O₅ from t₂ until the end of the actuation cycle is the combined response of the deactivating elements 14, 16, and is equivalent to the intermediate force output 34b which is greater than the intermediate force output of the deactivating element 16. The intermediate force output 34b of the deactivating element 14 corresponds to an intermediate shape at time t₂ which is partially transformed to an SMA structure which is more austenitic than the partially transformed SMA structure of element 14 at the end of the actuation cycle illustrated in FIGS. 6A and 6B. By sequentially activating and deactivating the stiffness elements 14, 16 as shown in FIG. 6B and previously described, the actuator 10 can provide an intermediate actuation output in the range O₅, to operate the actuated device continuously in the low to medium (L-M) range, where the intermediate actuation output O₅ is non-linear and thereby a smoother or more continuous actuation in a narrower range than that which may be obtainable by actuation of either of the stiffness elements 14, 16 individually.

The actuator 20 is therefore actuable to provide at least an output O₆ defining an intermediate actuation output, which is a combined output of stiffness elements 12 and 14 as the result of sequenced activation and deactivation of the elements 12, 14 to provide output forces 32a, 34a, 34b and 32b, and another output O₅ defining another intermediate actuation output, which is a combined output of stiffness elements 14 and 16 as the result of sequenced activation and deactivation of the elements 14, 16 to provide output forces 34a, 36a, 36b and 34b. The output O₆ using the combination of elements 12, 14 may be provided in response to substantially the same heat or power input used to provide the output O₅ from the combination of stiffness elements 14, 16.

In a non-limiting example, the actuator 10 may be included in a stiffness control system. The system may include an output element, which may be configured as, by way of non-limiting example, a pressure relief valve, which is operatively connected to the actuator 10, for example, by an actuable spring 19 such that the output element (e.g., the pressure relief valve) may be actuated by an output from the actuator 10 to be operable at an intermediate actuation. In the illustrative non-limiting example, intermediate actuation of the pressure relief valve is defined by opening the pressure relief valve to one or more intermediate positions which are between the fully closed position and the fully open position. The system may further include an input element, such as a pressure sensor, in operative communication with the actuator 10 or with a controller in operative communication with the actuator 10, and configured to activate the actuator to provide an intermediate actuation output corresponding to the sensed pressure, by activating at least one of the plurality of stiffness elements.

The actuating source, for example, the controller, may dynamically activate and de-activate one or more of the plurality of stiffness element 12, 14, 16 of the actuator 10 in response to the signals from the pressure sensor and changes in the operating characteristics, which in the non-limiting example provided herein are changes in the sensed pressure, such that the stiffness of the system, and therefore the position of the pressure relief valve, can be dynamically changed in response to changes in pressure. Using the actuator 10, the opening of the pressure relief valve, in the non-limiting example, may be finely controlled by activating the plurality of stiffness element 12, 14, 16 comprising the actuator 10 individually or in combination, sequentially or at intervals, and by partially or fully transforming the SMA material each is made of, to provide a wide range of operating (opening) settings or positions at which the pressure relief valve may be held. For example, in response to a sensed low pressure differential, the pressure relief valve may be slightly opened by activating and deactivating stiffness elements 14, 16 as discussed previously at a low to medium (L-M) setting corresponding to output range O₅ (see FIG. 6B). As an increase in pressure is sensed, the actuator 10 may actuate the pressure relief valve to open additionally to a medium (M) setting by activating stiffness element 16 individually, corresponding to the output range O₁ (see FIG. 4). As the sensor signals continually increasing pressure, the pressure relief valve may be opened wider by activating and deactivating stiffness elements 12, 14 as discussed previously between a medium to high (M-H) setting corresponding to output range O₆ (see FIG. 6B). When a further increase in pressure is sensed, the actuator 10 may actuate the pressure relief valve to open additionally to a high (H) setting by activating stiffness element 14 individually, corresponding to the output range O₂ (see FIG. 4). In a worst case scenario, e.g., requiring the highest amount of flow through the pressure relief valve or the widest opening of the valve, the actuator may actuate the pressure relief valve by activating stiffness element 12 individually, corresponding to the output range O₃ (see FIG. 4). It is understood that the actuator described may be adaptable to various systems where dynamic control of the stiffness of an actuated device or system is required to enhance the refinement of and increase the range of on-demand control of the actuated device or system, for example, in response to a sensed operating characteristic, and is not limited to the example of a valve described herein.

It would be understood that the system may also be configured to sense changes in the output range of a stiffness element which may be caused by or result from, for example, deterioration of the stiffness element. Changes in the output range of the stiffness element may be detected, for example, by sensing a change in the activated and deactivated length of the stiffness element, affecting or modifying the output of the actuator, which may be, for example a measure of displacement. The stiffness element may change, e.g., may deteriorate or become degraded, due to repeated use or in-service loads, designed or incidental, repeated actuations at high temperatures or high loads, or other factors affecting stiffness element performance, durability and reliability. The change or deterioration in stiffness element performance may be caused by, for example, aging, fatigue, shakedown, functional degradation, and/or elongation of the stiffness element material after repeated actuation.

The controller and actuator may be configured to adjust or modify the activation sequence or the combination of the plurality of stiffness elements activated, or the individual stiffness element activated to provide an output which compensates for the deterioration in or other changes in the output of one or more of the plurality of stiffness elements, to provide an equivalent output, e.g., a functionally substitutional output, for the output provided prior to the deterioration or other change. Similarly, the controller and/or actuator may be additionally configured to adjust the activation or modify the activation sequence or the combination of the plurality of stiffness elements activated, or the individual stiffness element to provide an output which compensates for other system changes, such as wear or deterioration of the actuated device or element, changes in operating environment such as changes in the ambient temperature or humidity in which the actuated device and/or the actuator are operated, etc., which require a modification in the actuator output to provide the required operating condition of the actuated device.

An actuator 20 is shown in FIG. 3. The actuator 20 includes a plurality of SMA elements, which in a non-limiting example, includes a first, second and third SMA element 22, 24 and 26, where the SMA elements 24, 26 are configured in series with each other and in parallel with the SMA element 22. Each of the SMA elements 22, 24, 26 are actuable individually or in combination with one or more of the other SMA elements. Each of the plurality of stiffness elements may be configured differently from one or more of the other stiffness elements. For example, a stiffness element may be configured as a SMA wire, a SMA spring, or may have a different cross-section or diameter than another of the plurality of stiffness elements. One or more of the plurality of stiffness elements may be configured of an SMA material which is different from the SMA material used for another of the stiffness elements. At least one of the plurality of stiffness elements comprising the actuator 20 has a stiffness characteristic which is different from at least another of the plurality of stiffness elements.

In the non-limiting example, referring to FIG. 1 and wherein K₁<K₂<K₃, the first SMA element 22 is defined by a force/stress output 32, a stroke/strain output 42, and a stiffness characteristic K₃. The second stiffness element 24 is defined by a force/stress output 34, a stroke/strain output 44, and a stiffness characteristic K₂. The third stiffness element 26 is defined by a force/stress output 36, a stroke/strain output 46, and a stiffness characteristic K₁.

The ends of each of the plurality of SMA wires 22, 24, 26 in the actuator 20 are connected to an actuating source, for example, an electrical circuit through which current may be provided to each of the SMA elements 22, 24, 26 such that each of the SMA elements 22, 24, 26 is actuable by elevating the temperature of the respective SMA element through resistance heating. In a non-limiting example, each of the SMA elements 22, 24, 26 may be operatively connected to one or more sensors or switches, or to a controller which is responsive to at least one sensor, where the at least one sensor is sensing an operating characteristic of a system, and providing a signal to the wire, switch or controller in response to changes in the operating characteristic being sensed. Other methods of thermally actuating the SMA elements 22, 24, 26 may be employed, as would be understood by those skilled in the art.

The actuating source may be, as shown in FIG. 3, a switch and a power supply such that when the switch is closed, an electrical current is flowed from the power supply to the SMA wire and heat is generated by a resistance of the wire itself, increasing the temperature of the wire sufficiently such that the SMA wire is activated and begins to transform from its martensitic state to its austenitic state, e.g., from its second shape to its first shrunk or predetermined shape, providing a tensile force on the spring 29. When the switch is turned off or opened to shut off or cease the supply of electrical current to the SMA element, the SMA element is deactivated and cools, such that it transforms to its second shape, thereby extending in length and in so doing, providing a compressive force from the actuator 20 against the spring 29.

FIG. 3 shows the first SMA element 22 operatively connected to a switch and a power supply such that the switch 23 may be closed to provide a current to the SMA element 22, thus heating the element 22. The switch 23 may be opened to cease the supply of current to element 22, causing element 22 to decrease in temperature. Similarly, the second SMA element 24 is operatively connected to a switch 25 and a power supply, and the third SMA element 26 is operatively connected to a switch 27 and a power supply. The power supply may be configured as an individual power supply for each element or as a shared power supply for two or more of the SMA elements 22, 24, 26.

The actuator 20 further includes a bias spring 28. The bias spring 28 may be configured to provide a nominal bias force on each of the SMA elements 22, 24, 26 in their respective second shape, to assist with the return of the SMA element from the first shape to the second shape during the cooling portion of the actuation cycle. The actuator 20 may include more than one bias spring, such that each SMA element 22, 24, 26 may have its own bias spring corresponding to the individual configuration of that specific SMA element.

The actuator 20 includes an actuable spring 29, which may be operably connected to an actuable device (not shown). By changing the shape of one or more of the SMA elements 22, 24, 26, the actuator 20 actuates the actuable device via the actuable spring 29, by applying a force to or against the actuable spring 29 such that the actuable spring 29 is compressed or extended. The actuable spring 29 may be operatively connected to a device/member/etc. such that compression or extension of the actuable spring 29 causes the device/member/etc. to be activated. For example, the actuable spring 29 may be operatively connected to an actuable device, such as a vent or valve such that the actuable spring 29 may be actuated by actuator 20 to cause the vent or valve to be opened or closed.

By configuring an actuator with a plurality of actuable stiffness elements in parallel (as shown and previously discussed for the actuator 10 in FIG. 2), in series, or in a combination of thereof (as shown for the actuator 20 in FIG. 3), with an actuable device (via the actuable spring 19, 29 in FIGS. 2, 3 respectively), an actuable stiffness element or a plurality of combinations of actuable stiffness elements may be activated and deactivated at various times, in various sequences, and/or by fully or partially transforming the SMA material of the element, to provide a specific and refined response to input conditions, which may include an intermediate actuation response or output, therefore enhancing the capability to respond to multiple variables and a broader scope of inputs. The actuator 20 can provide each of the individual force output ranges O₃, O₄, O₅, by individually activating the stiffness elements 26, 24, 22, respectively.

As was discussed previously for the actuator 10, the stiffness elements 22, 24 of the actuator 20 of FIG. 3 may be actuated to provide the combined and intermediate output O₆ shown in FIG. 6B, by sequentially activating and deactivating the stiffness elements 22, 24, which are configured in parallel in the actuator 20, in the same manner as detailed for the stiffness elements 12, 14, respectively.

Further, the actuator 20 can provide a fourth force output range O₄ shown in FIG. 5, by activating the stiffness elements 24 and 26 in series to provide a force output indicated at 38 in FIG. 5 which is the combined force output of the force outputs 34, 36 in series. The output range O₄ provided by the combined output of the stiffness elements 24, 26 significantly overlaps the output range O₃ of the stiffness element 32, such that the actuator 20 may be configured to provide the combined output force 38 as a functionally substitutional output force for the individual output force 32 of the stiffness element 12. Where used herein, the term “functionally substitutional” output is intended to indicate an output provided by the actuator to the actuated device, such that the operation of the actuated device in response to the functionally substitutional output is substantially similar to the operation of the actuated device in response to the output for which the functionally substitutional output is substituted. Configured as such, the actuator 20 may activate the stiffness elements 24 and 26 in series to provide output 38 defining an output range O₄, as a functional substitution for the output 32 of the stiffness element 22 defining an output range O₃, for example, if the stiffness element 22 fails or degrades such that the stiffness element is not functional to produce the maximum output of output range O₃ required for proper actuation of the actuated device. This configuration may provide a functional redundancy, for example, in a device where the maximum of output range O₃ represents a worst case functional requirement which must be satisfied with a high level of reliability. In this configuration, the series combination of stiffness elements 24 and 26 would be actuable as a functional substitution of stiffness element 22, such that the combination of the stiffness elements 24 and 26 would be redundant of the stiffness element 22 and therefore increasing the overall reliability of the system or device to respond to a worst case operating requirement.

In a non-limiting example, the actuator 20 may be included in a stiffness control system. The system may include an output element which may be, by way of non-limiting example, a pressure relief valve, which is operatively connected to the actuator 20, for example, by an actuable spring 29 such that the output element may be actuated by an output from the actuator 20 to be operable at an intermediate actuation. In the illustrative non-limiting example, intermediate actuation of the pressure relief valve is defined by opening the pressure relief valve to one or more intermediate positions which are between the fully closed position and the fully open position. The system may further include an input element, such as a pressure sensor, in operative communication with the actuator 20 or with a controller in operative communication with the actuator 20, and configured to activate the actuator to provide an intermediate actuation output corresponding to the sensed pressure, by activating at least one of the plurality of stiffness elements.

The actuating source, for example, the controller, may dynamically activate and de-activate one or more of the plurality of stiffness element 22, 24, 26 of the actuator 20 in response to the signals from the pressure sensor and changes in the operating characteristics, which in the non-limiting example provided herein are changes in the sensed pressure, such that the stiffness of the system, and therefore the position of the pressure relief valve, can be dynamically changed in response to changes in pressure. Using the actuator 20, the opening of the pressure relief valve may be finely controlled by activating the plurality of stiffness element 22, 24, 26 comprising the actuator 20 individually or in combination, sequentially or at intervals and by partially or fully transforming the SMA material each is made of, to provide a wide range of operating (opening) settings at which the pressure relief valve may be held. For example, in response to a sensed low pressure differential, the pressure relief valve may be slightly opened to a medium (M) setting by activating stiffness element 16 individually, corresponding to the output range O₁ (see FIG. 4). As an increase in pressure is sensed, the actuator 20 may actuate the pressure relief valve to open additionally by activating and deactivating stiffness elements 22, 24 as discussed previously between a medium to high (M-H) setting corresponding to output range O₆ (see FIG. 6B). As the sensor signals continually increasing pressure, the pressure relief valve may be opened wider to a high (H) setting by activating stiffness element 14 individually, corresponding to the output range O₂ (see FIG. 4). When a further increase in pressure is sensed, the actuator 20 may actuate the pressure relief valve to open additionally by activating stiffness element 26 individually and corresponding to the output range O₃ (see FIG. 4). In a worst case scenario, e.g., requiring the highest amount of flow through the pressure relief valve or the widest opening of the valve, or in the event of failure or deterioration of the stiffness element 26, the actuator may actuate the pressure relief valve by activating the stiffness elements 24 and 26 in series, corresponding to the output range O₄ (see FIG. 5). It is understood that the actuator described may be adaptable to various systems where dynamic control of the stiffness of an actuated device or system is required to enhance the refinement of and increase the range of on-demand control of the actuated device or system, for example, in response to a sensed operating characteristic.

It would be understood that the system may also be configured to sense changes in the output range of a stiffness element which may be caused by or result from, for example, deterioration of the stiffness element. Changes in the output range of the stiffness element may be detected, for example, by sensing a change in the activated and deactivated length of the stiffness element, affecting or modifying the output of the actuator, which may be, for example a measure of displacement. The stiffness element may change, e.g., may deteriorate or become degraded, due to repeated use or in-service loads, designed or incidental, repeated actuations at high temperatures or high loads, or other factors affecting stiffness element performance, durability and reliability. The change or deterioration in stiffness element performance may be caused by, for example, aging, fatigue, shakedown, functional degradation, and/or elongation of the stiffness element material after repeated actuation.

Similarly, the controller and/or actuator may be additionally configured to adjust the activation or modify the activation sequence or the combination of the plurality of stiffness elements activated, or the individual stiffness element to provide an output which compensates for other system changes, such as wear or deterioration of the actuated device or element, changes in the operating environment of the actuator and/or actuated device, such as changes in the ambient operating temperature or humidity, etc., which require a modification in the actuator output to provide the required operating condition of the actuated device.

Other activation sequences are possible, including sequential activations and deactivations of a plurality of combinations of the stiffness elements comprising actuator 10 and actuator 20, or of other configurations of a plurality of stiffness elements in parallel, series, or a combination thereof to comprise an actuator. Various activation/deactivation sequences, which may include partial transformations from increasingly/decreasingly austenitic shapes may be configured to more narrowly refine the combined output of the actuator to provide a non-linear actuator output, which may be defined by a non-linear or a smoothed profile.

Other configurations of the actuator and system described herein are possible. For example, the actuators 10 and 20 may include any number of SMA elements configured in various shapes and defined by various force/stress and stroke/strain output curves and stiffness characteristics. Further, the SMA elements may be defined in any combination of series and parallel configurations as required to provide the intermediate actuation output desired for the actuator and/or operation of the actuated device.

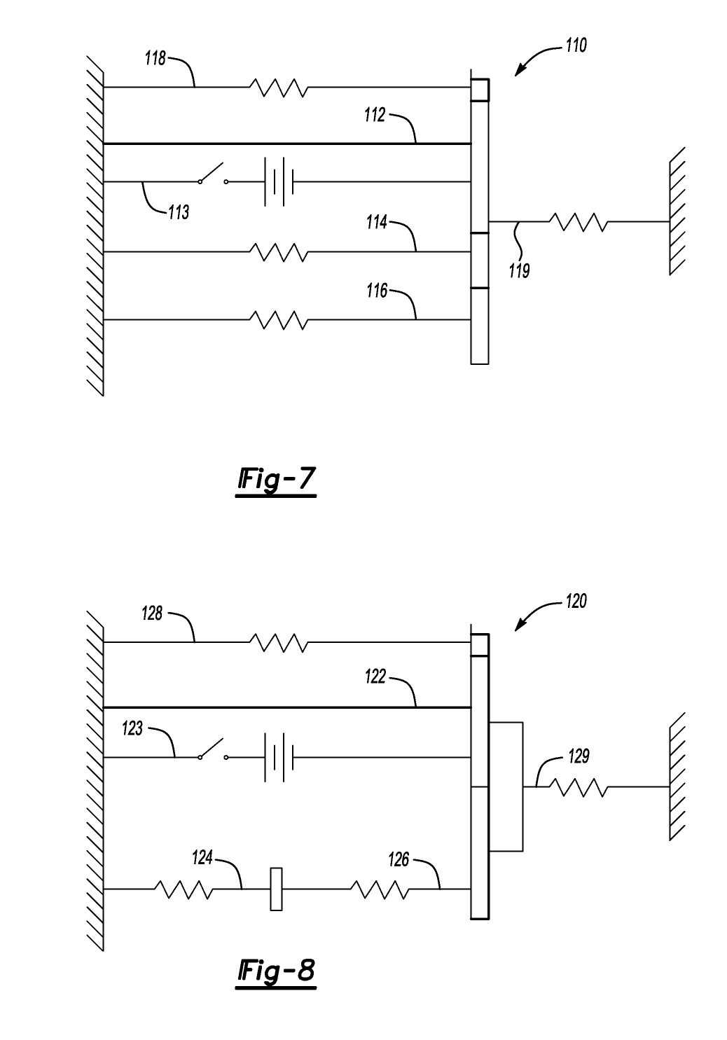

The plurality of stiffness elements may be configured, in a non-limiting example, as a first stiffness element which is an SMA element 112 in combination with a second and third stiffness element 114 and 116 as shown in FIG. 7, or may be configured, in another non-limiting example, as a first stiffness element which is an SMA element 122, in combination with a second and third stiffness element 124 and 126 as shown in FIG. 8. The first stiffness element 112, 122, which is an SMA stiffness element as described previously, may be characterized by a force/stress output such as the force/stress output indicated at 32 and a stroke/strain output such as the stroke/strain output indicated at 42 in FIG. 1, and may be further characterized by a stiffness characteristic K₃. The second and third stiffness elements 114,124 and 116, 126 may each be configured as a non-SMA stiffness element. By way of non-limiting example, the non-SMA stiffness element may be configured as a bi-metallic strip in combination with a spring, where the bi-metallic strip deforms in response to temperature change to selectively connect the spring. As another example, the non-SMA stiffness element may include a flexible cantilever bendable to selectively couple different stiffness elements or springs. The non-SMA stiffness elements may be configured as any type of spring which may be selectively actuated and used to bias or tune the at least one SMA element 112. These examples are intended to be non-limiting and other configurations of springs and/or non-SMA stiffness elements may be included. The second stiffness element 114, 124 may each be characterized by a stiffness characteristic K₄. The third stiffness element 116, 126 may be characterized by a stiffness characteristic K₅. In the non-limiting examples shown in FIGS. 7 and 8, the stiffness characteristics are such that K₁≠K₄≠K₅, such that the stiffness elements may be activated and deactivated individually at various times and in various sequences to provide a specific and refined response to input conditions, which may include an intermediate actuation response or output, as described previously for FIGS. 2 and 3.

An actuator 110 is shown in FIG. 7. The actuator 110 includes a plurality of stiffness elements, which in a non-limiting example, includes a first, second and third stiffness element 112, 114 and 116 configured in parallel with each other, such that each of the stiffness elements 112, 114, 116 are actuable individually or in combination with one or more of the other stiffness elements. Each of the plurality of stiffness elements may be configured differently from one or more of the other stiffness elements. In the non-limiting example shown in FIG. 7, one of the elements is a SMA element 112, and the other elements 114, 116 are non-SMA elements. It would be understood that any combination or number of SMA elements and non-SMA elements may be used to configure the actuator 110 as described herein, to provide a tunable actuator. The stiffness element 112, which in actuator 110 is configured as a SMA stiffness element, may include a SMA wire, a SMA spring, or may have a different cross-section or diameter or SMA material than another SMA stiffness element included in the plurality of stiffness elements.

Each of the plurality of stiffness elements 112, 114, 116 in the actuator 110 are operatively connected to an actuating source, for example, an electrical circuit as described previously for FIG. 2. Other actuating sources may be, for example, thermal, displacement, etc. In a non-limiting example, each of the stiffness elements 112, 114, 116 may be operatively connected to one or more sensors or switches, or to a controller which is responsive to at least one sensor, where the at least one sensor is sensing an operating characteristic of a system, and providing a signal to the wire, switch or controller in response to changes in the operating characteristic being sensed. Other methods of actuating the stiffness elements 112, 114, 116 may be employed, as would be understood by those skilled in the art. FIG. 7 shows the first SMA element 112 operatively connected to a switch and a power supply such that the switch 113 may be closed to provide a current to the SMA element 112, thus heating the element 112. The switch 113 may be opened to cease the supply of current to element 112, causing element 112 to decrease in temperature.

The actuator 110 further includes a bias spring 118. The bias spring 118 may be configured to provide a nominal bias force on each of the stiffness elements 112, 114, 116 to assist with the return of the stiffness element from an actuated shape to a non-actuated shape. The actuator 110 includes an actuable spring 119, which may be operatively connected to an actuable device (not shown). By activating one or more of the stiffness elements 112, 114, 116, the actuator 110 actuates the actuable device via the actuable spring 119, by applying a force to or against the actuable spring 119 such that the actuable spring 119 is compressed or extended. The actuable spring 119 may be operatively connected to a device/member/etc. such that compression or extension of the actuable spring 119 causes the device/member/etc. to be activated. For example, the actuable spring 119 may be operatively connected to an actuable device such as a vent or a valve such that the actuable spring 119 may be actuated by actuator 110 to cause the vent or the valve to be opened or closed.

An actuator 120 is shown in FIG. 8. The actuator 120 includes a plurality of stiffness elements, which in a non-limiting example, includes a first, second and third stiffness element 122, 124 and 126 where the stiffness elements 124, 126 are configured in series with each other and in parallel with the stiffness element 122, such that each of the stiffness elements 122, 124, 126 are actuable individually or in combination with one or more of the other stiffness elements. Each of the plurality of stiffness elements may be configured differently from one or more of the other stiffness elements. In the non-limiting example shown in FIG. 8, one of the elements is a SMA element 122, and the other elements 124, 126 are non-SMA elements. It would be understood that any combination or number of SMA elements and non-SMA elements may be used to configure the actuator 120 as described herein, to provide a tunable actuator. The stiffness element 122, which in actuator 120 is configured as a SMA stiffness element, may include a SMA wire, a SMA spring, or may have a different cross-section or diameter or SMA material than another SMA stiffness element included in the plurality of stiffness elements.

Each of the plurality of stiffness elements 122, 124, 126 in the actuator 120 are operatively connected to an actuating source, for example, an electrical circuit as described previously for FIG. 3. Other actuating sources may be, for example, thermal, displacement, etc. In a non-limiting example, each of the stiffness elements 122, 124, 126 may be operatively connected to one or more sensors or switches, or to a controller which is responsive to at least one sensor, where the at least one sensor is sensing an operating characteristic of a system, and providing a signal to the wire, switch or controller in response to changes in the operating characteristic being sensed. Other methods of actuating the stiffness elements 122, 124, 126 may be employed, as would be understood by those skilled in the art. FIG. 8 shows the first SMA element 122 operatively connected to a switch and a power supply such that the switch 123 may be closed to provide a current to the SMA element 122, thus heating or activating the element 122. The switch 123 may be opened to cease the supply of current to element 122, deactivating the element 122 and causing the element 122 to decrease in temperature.

The actuator 120 further includes a bias spring 128. The bias spring 128 may be configured to provide a nominal bias force on each of the stiffness elements 122, 124, 126 to assist with the return of the stiffness element from an actuated shape to a non-actuated shape. The actuator 120 includes an actuable spring 129, which may be operatively connected to an actuable device (not shown). By activating one or more of the stiffness elements 122, 124, 126, the actuator 120 actuates the actuable device via the actuable spring 129, by applying a force to or against the actuable spring 129 such that the actuable spring 129 is compressed or extended. The actuable spring 129 may be operatively connected to a device/member/etc. such that compression or extension of the actuable spring 129 causes the device/member/etc. to be activated. For example, the actuable spring 129 may be operatively connected to an actuable device such as a vent or a valve such that the actuable spring 129 may be actuated by actuator 120 to cause the vent or the valve to be opened or closed.

By configuring an actuator with a plurality of actuable stiffness elements in parallel (as shown for actuator 110 in FIG. 7), in series, or in a combination thereof (as shown for actuator 120 in FIG. 8), with an actuable device (via the actuable spring 119, 129 in FIGS. 7,8 respectively), and as described previously for FIGS. 2 and 3, a stiffness element or a plurality of combinations of actuable stiffness elements may be activated and deactivated at various times and in various sequences to provide a specific and refined response to input conditions, which may include an intermediate actuation response or output, therefore enhancing the capability to respond to multiple variables and a broader scope of inputs.

The smart actuators discussed herein may comprise other configurations of SMA material such as SMA ribbon, SMA film, SMA cable, SMA embedded composite materials, and configurations formed from SMA bulk materials such as SMA powder metal. In addition to the advantages previously discussed, the system and apparatus provided herein can accommodate rapid changes in stiffness, for example, within a few milliseconds.

While the best modes for carrying out the invention have been described in detail, those familiar with the art to which this invention relates will recognize various alternative designs and embodiments for practicing the invention within the scope of the appended claims.

1. An actuator adaptable for tunable stiffness control, the actuator comprising:
a plurality of stiffness elements, one or more of the plurality of stiffness elements including a smart material;
wherein at least one of the plurality of stiffness elements has a stiffness characteristic which is different from at least another of the plurality of stiffness elements;
wherein the actuator is configured to actuate at least one of the plurality of stiffness elements to provide an intermediate actuation output.

2. The actuator of claim 1,
wherein the plurality of stiffness elements is configured such that at least two of the plurality of the stiffness elements are actuable in combination to provide a combined output; and
wherein the combined output defines the intermediate actuation output.

3. The actuator of claim 1, wherein the intermediate actuation output is non-linear.

4. The actuator of claim 1, wherein one or more of the plurality of stiffness elements is actuated by partially transforming the smart material of the one or more of the plurality of stiffness elements to provide the intermediate actuation output.

5. The actuator of claim 1, wherein the smart material is a shape memory alloy (SMA) defining one of a SMA wire and a SMA spring.

6. The actuator of claim 1, wherein at least two of the plurality of stiffness elements are configured to provide a combined output which is functionally substitutional for an individual output of at least one other of the plurality of stiffness elements.

7. The actuator of claim 1,
wherein the plurality of stiffness elements is actuable to provide one of a first output defining a first intermediate actuation output and a second output defining a second intermediate actuation output.

8. The actuator of claim 2, wherein at least two of the plurality of stiffness elements are configured as one of:
actuable in parallel with each other,
actuable in series with each other, and
actuable in a combination of parallel and series with each other, to provide the combined output.

9. A method for providing tunable stiffness control, the method comprising:
providing an actuator comprised of a plurality of stiffness elements, one or more of the plurality of stiffness elements including a smart material, wherein at least one of the plurality of stiffness elements has a stiffness characteristic which is different from at least another of the plurality of stiffness elements;
selectively actuating at least one of the plurality of stiffness elements to provide an actuator output including an intermediate actuation output.

10. The method of claim 9, wherein the smart material is a shape memory alloy (SMA) defining one of a SMA wire and a SMA spring.

11. The method of claim 9, wherein selectively actuating at least one of the plurality of stiffness elements to provide an intermediate actuation output further comprises:
partially transforming the smart material of at least one of the plurality of stiffness elements.

12. The method of claim 9, further comprising:
providing the actuator output to an output element operatively connected to the actuator, such that the output element is operable at an intermediate actuation.

13. The method of claim 12, further comprising:
monitoring the actuator output to detect change in the actuator output resultant from deterioration of one or more of the plurality of stiffness elements due to one or more of fatigue, functional degradation, aging, shakedown, and elongation of the one or more of the plurality of stiffness elements;
selectively actuating at least one of the plurality of stiffness elements to provide an actuator output which offsets the deterioration.

14. The method of claim 9, wherein selectively actuating at least one of the plurality of stiffness elements to provide the actuator output including the intermediate actuation output further comprises:
providing an input to the actuator;
activating the actuator in response to the input to provide the intermediate actuation output, wherein the actuator output is defined by the input.

15. The method of claim 9, wherein at least two of the plurality of stiffness elements are configured to provide a combined output, and at least one other of the plurality of stiffness elements is configured to provide an individual output wherein the combined output and the individual output are functionally substitutional for each other, the method further comprising:
actuating the actuator to provide one of the individual output and the combined output;
monitoring the output of the actuator to determine whether the one of the individual output and the combined output has been provided; and
actuating the actuator to provide the other of the individual output and the combined output when the one of the individual output and the combined output has not been not provided.

16. The method of claim 9, further comprising:
providing an input to the actuator, wherein the input is configured to activate the actuator in response to the input to provide one of a first intermediate actuation output and a second intermediate actuation output.

17. A tunable stiffness control system comprising:
an actuator including a plurality of stiffness elements, one or more of the plurality of stiffness elements including a smart material, wherein at least one of the plurality of stiffness elements has a stiffness characteristic which is different from at least another of the plurality of stiffness elements;
an output element operatively connected to an actuator, wherein the output element is actuated by an output from the actuator; and
an input element in operative communication with the actuator, wherein the input element is configured to actuate at least one of the plurality of stiffness elements to provide an intermediate actuation output;
wherein the actuator is configured to actuate at least one of the plurality of stiffness elements to provide the output which is the intermediate actuation output to the output element.

18. The system of claim 17, wherein at least one of the plurality of stiffness elements is actuated by partially transforming the smart material of the at least one of the plurality of stiffness elements to provide the intermediate actuation output.

19. The system of claim 17, wherein the intermediate actuation output is non-linear.

20. The system of claim 17, wherein the actuator is configured to selectively actuate at least one of the plurality of stiffness elements to offset change in one or more of the plurality of stiffness elements, wherein the change is resultant from one or more of fatigue, function degradation, aging, shakedown, and elongation of the one or more of the plurality of stiffness elements.
